(19) United States
(12) Patent Application Publication
(10) Pub. No.: US 2003/0044330 A1
(43) Pub. Date: Mar. 6, 2003

(54) Solid material and process for adsorption and desorption of nitrogen oxides in exhaust gases of internal combustion engines

(76) Inventors: Renato Andorf, Immenstaad (DE); Josef Guenther, Affalterbach (DE); Brigitte Konrad, Blaustein (DE); Bernd Krutzsch, Denkendorf (DE); Werner Maunz, Markdorf (DE); Carsten Plog, Markdorf (DE); Guido Schaeffner, Horgenzell (DE); Dirk Voigtlaender, Korntal-Muenchingen (DE); Wolfgang Wagner, Ravensburg (DE); Michel Weibel, Stuttgart (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/189,780

(22) Filed: Jul. 8, 2002

(30) Foreign Application Priority Data
Jul. 6, 2001 (DE) DE 101 32 890.7

(51) Int. Cl. B01D 53/56; B01D 53/94

(52) U.S. Cl. 422/177; 423/213.2; 423/213.5; 423/235

(57) ABSTRACT

A solid material for adsorption of nitrogen oxides in an oxidizing atmosphere and desorption of nitrogen oxides in a reducing atmosphere in gases, such as internal combustion engine exhaust gases, can comprise a porous support, at least one metal component, and at least one transition metal component. A process for adsorption and desorption of nitrogen oxides in gases, such as internal combustion engine exhaust gases, can comprise the use of at least one solid material.

### BACKGROUND AND SUMMARY OF THE INVENTION

This application claims the priority of German Patent Document DE 101 32 890.7, filed Jul. 6, 2001, the disclosure of which is expressly incorporated by reference herein.

The present invention concerns a solid material for absorption and desorption of nitrogen oxides in gases. The solid material comprises a porous support, at least one metal component, and at least one transition metal component. The present invention also concerns a process for adsorption and desorption of nitrogen oxides in gases using the solid material.

An alkaline metal or alkaline earth metal-containing NOₓ storage material with catalytic properties is known from published patent specification EP 0 890389. The NOₓ storage material described therein contains, in addition to the alkaline earth metal, a noble metal component such as, for example, platinum with a so-called catalytic three-way property. The noble metal component fulfills the oxidation task which is indispensable for the storage of NOₓ. The oxidation of NOₓ is catalyzed which is necessary for NOₓ storage with the material, as the NOₓ is stored in an oxidizing atmosphere by formation of a nitrate compound with the alkaline earth metal.

Since nitrogen is present in nitrogen oxide with a valence of two (NO) or four (NO₂), but with a valence of five in the form of a nitrate, the oxidation step brought about by the noble metal component with these materials is indispensable for NOₓ storage. With a change to reducing environmental conditions, the nitrate decomposes while releasing nitrogen oxides again. The existing catalytically operating noble metal component brings about the reduction of released nitrogen oxides with the reducing agents present in the gas. With the NOₓ-accumulating materials mentioned, concurrent reduction of nitrogen oxides in the NOₓ storage materials and desorption are a necessary consequence of the presence of the noble metal components. Without the noble metal components, the storage of nitrogen oxides in an oxidizing atmosphere is not possible.

The NOₓ-accumulating materials mentioned are proposed for use with exhaust gases and typically develop their effectiveness in a restricted temperature range.

One object of the invention is to provide a solid material and a process with which the absorption and desorption of NOₓ can be realized in a temperature range suited for internal combustion engine exhaust gases.

This objective is accomplished by a solid material which comprises a porous support; a metal component selected from the group consisting of alkaline metals, alkaline earth metals and rare earth metals; and a transition metal component selected from the group consisting of titanium (Ti), vanadium (V), chromium (Cr), manganese (Mn), iron (Fe), cobalt (Co), zinc (Zn), zirconium (Zr), niobium (Nb), molybdenum (Mo), silver (Ag), hafnium (Hf), tungsten (W); and a main group metal component selected from the group consisting of indium (In), tin (Sn), antimony (Sb), lead (Pb), and bismuth (Bi). The objective is further accomplished by a process where a single solid material adsorbs and desorbs nitrogen oxides, the single solid material comprising a porous support; a metal component selected from the group consisting of alkaline metals, alkaline earth metals and rare earth metals; and a transition metal component selected from the group consisting of titanium (Ti), vanadium (V), chromium (Cr), manganese (Mn), iron (Fe), cobalt (Co), zinc (Zn), zirconium (Zr), niobium (Nb), molybdenum (Mo), silver (Ag), hafnium (Hf), tungsten (W); and a main group metal component selected from the group consisting of indium (In), tin (Sn), antimony (Sb), lead (Pb), and bismuth (Bi).

In accordance with the invention, the solid material adsorbs or stores NOₓ in an oxidizing atmosphere. The solid desorbs the stored NOₓ upon either heating above a certain desorption temperature or upon a change to a reducing atmosphere. A further characteristic of the solid material of the invention is that it has a porous, or microporous substrate. This provides a large amount of inner and outer surface areas, and therewith a good contact of the NOₓ-containing gas with the solid material Furthermore, the solid material is wherein it contains at least one metal component which contains a metal selected from the group consisting of alkaline metals, alkaline earth metals and rare earth metals. This base-acting metal component largely takes over binding NOₓ to the solid material. Thus NOₓ is chiefly bound in nitrate form. Other forms of binding, such as binding with nitrite or binding based upon chemisorption or physiosorption, can occur.

The solid material according with to the invention also comprises a transition metal selected from the group consisting of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), silver (Ag), hafnium (Hf), and tungsten (W) and/or at least one main group metal component with a main group metal selected from the group consisting of indium (In), tin (Sn), antimony (Sb), lead (Pb), and bismuth (Bi). Particularly advantageous properties result with the use of the transition metal components V, Mn, Fe, Cu, and Ag.

The components mentioned bestow upon the solid material a certain oxidation-catalytic property. In this way, the oxidation of NOₓ for example, into the nitrate form, can take place in an oxidizing atmosphere, where the process of NOₓ storage is enabled or supported. The components mentioned have little or no three-way characteristic available, such as that possessed by the noble metal components platinum or rhodium. These three-way properties enhance the typical NOₓ storage catalysts such that the nitrogen oxides desorbed out of the storage material in a reducing atmosphere are for the most part immediately reduced. In contrast, the solid material of the invention catalyzes the reduction of desorbed nitrogen into nitrogen, after desorption of the nitrogen oxides. The nitrogen oxides desorbed under reducing conditions consequently are available for a subsequent treatment step in enriched form. This subsequent treatment step can consist of, for example, a reduction in a three way catalyst connected downstream in series.

Advantageously, the transition metal component or the main group metal component is applied to the same porous support on which the metal component is applied. However, the application of the components (metal, transition metal, main group metal components) on different porous supports is possible.

In a further embodiment of the invention, the porous carrier contains at least one component selected from the group consisting of aluminum oxide (Al₂O₃), zirconium oxide (ZrO₂), titanium dioxide (TiO₂), and silicon dioxide (SiO₂). The components mentioned can be used in any desired chemical modification. Preferably the component most suited with respect to the specific surface or thermal and chemical stability is used.

In a further embodiment of the invention, the alkaline metal is at least one metal selected from the group consisting of sodium (Na), potassium (K), rubidium (Rb), and cesium (Cs). The alkaline earth metal is at least one metal selected from the group consisting of magnesium (Mg), calcium (Ca), strontium (Sr), and barium (Ba). The rare earth metal is at least one metal selected from the group consisting of lanthanum (La), cerium (Ce), praseodymium (Pr), neodymium (Nd), samarium (Sm), europium (Eu), gadolinium (Gd), terbium (Tb), and dysprosium (Dy). Experimentation established that solid material of the invention, when prepared with the above-mentioned elements, possesses advantageous NOₓ storage properties. Especially advantageous NOₓ storage properties are developed with the use of one or more of the elements Na, K, Mg, Ca, Sr, Ba, La, and Ce.

In a further embodiment of the invention, the real storage component of the solid material (the alkaline metal, the alkaline earth metal, or the rare earth metal), exists as an oxide and/or in a combination as hydroxide, in a compound as carbonate, or as an element. Corresponding transformations can occur during use according to the composition of the exhaust gas.

Further embodiments similarly provide the transition metal and/or the main group metal as oxide and/or in a compound as hydroxide, a compound as carbonate, or as an element.

In yet another embodiment of the present invention, the metal component, the transition metal component, and the main group metal component can form a mixed oxide with another one of the components and be a component of the solid material. The mixed oxide can exist as such prior to application on the porous substrate, or be formed on the substrate in the course of the preparation process, or be formed in the course of practical use. Moreover, a large number of different mixed oxides come into question with the most varied crystal forms. By applying certain mixed oxides, the character of the components acting as NOₓ storage, or as oxidizers of the catalytically-acting component of the solid material, can advantageously be selectively influenced.

The metal component and the transition metal component or the main group metal component can be present in several layers which, for example, can be attained with selective preparation.

In accordance with a further embodiment, the metal component and the transition metal component or the main group metal component can be present as a powder mixture on the support. This can be attained when a powder mixture of the initial component, for example, a corresponding oxide, is mechanically prepared, preferably in a suspension, and applied to the support with the preparation.

According to a further embodiment, the solid material of the invention is applied to a mechanical or geometrical support, such as a ceramic support or a metal support. To extend the temperature range of efficacy, or for other reasons, it is advantageous for various executions of the solid material of the invention to be applied on various mechanical supports arranged one behind the other. The solid material can, however, also itself be constructed as a shaped element, owing to which applying it to the mechanical support is spared, and a greater amount of the active material can be made available. The inert mechanical support or the solid material constructed as a molded element can be constructed as a honeycomb element, or as a pellet, or in another form.

The process according to the invention is distinct because a solid material is used for both adsorption and desorption. The process is particularly suited for treating exhaust gases of internal combustion engines. Preferably the solid material used is constructed with a high NOₓ storage capacity. In this way, the nitrogen oxide adsorption can be maintained under oxidizing (lean) conditions for a long period of time and the internal combustion engine can therefore also be operated over a long period of time in the consumption-saving lean mode. Advantageously, the desorption of the nitrogen oxide takes place after switching into the rich operation mode of the internal combustion engine for a very short time. This operation, which is relatively unfavorable for consumption, must be maintained only for a very short time. In this NOₓ desorption phase, preferably the entire NOₓ amount stored in the preceding lean operation is abruptly free and is available in enriched form for further processing. This further processing or treatment can be in a catalytically supported reaction on a catalytic converter connected downstream from the solid material, or also in a feedback into the combustion chamber of the internal combustion engine.

The effectiveness of the process can be increased in accordance with a further embodiment in that at least two separate molded elements are used for adsorption or desorption of the nitrogen oxides which are coated with the solid material of the invention or are even made of the solid material of the invention. Preferably the molded elements are arranged serially in the exhaust gas flow of the internal combustion engine.

In a further embodiment of the process in accordance with the invention, the desorption of nitrogen oxides by the solid material of the invention is followed by conversion into harmless nitrogen in a subsequent, preferably catalytic, treatment step.

The invention will be discussed in greater detail below with reference to the drawings and associated examples.

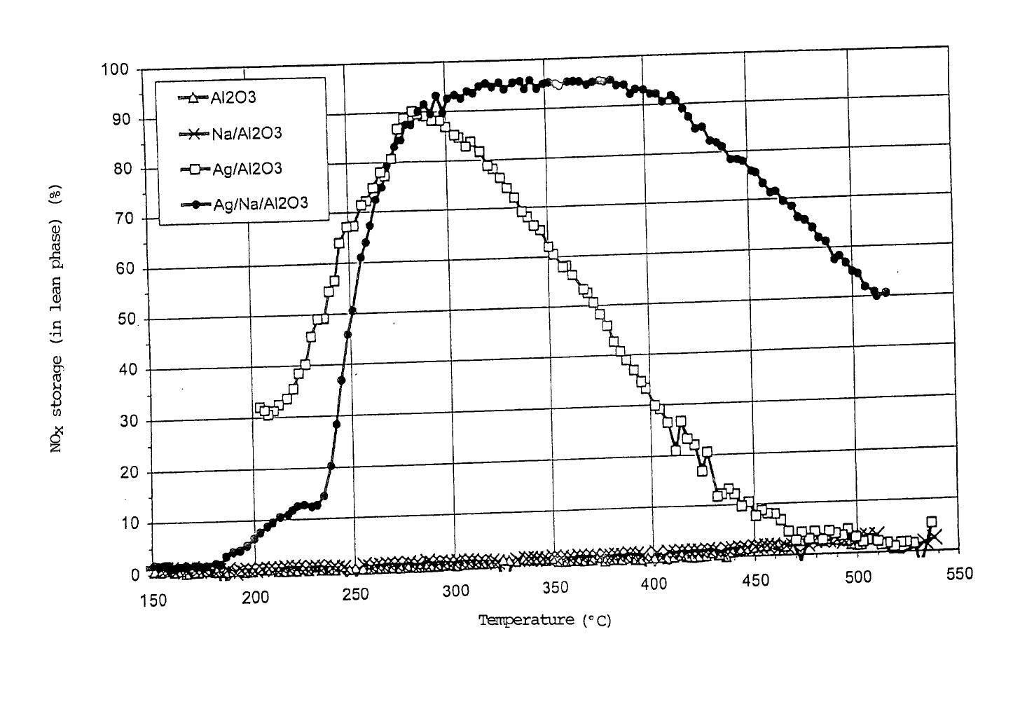

FIG. 1 presents a diagram which represents the NOₓ storage of various solid materials in the an part of a lead-rich shifting operation as a function of temperature;

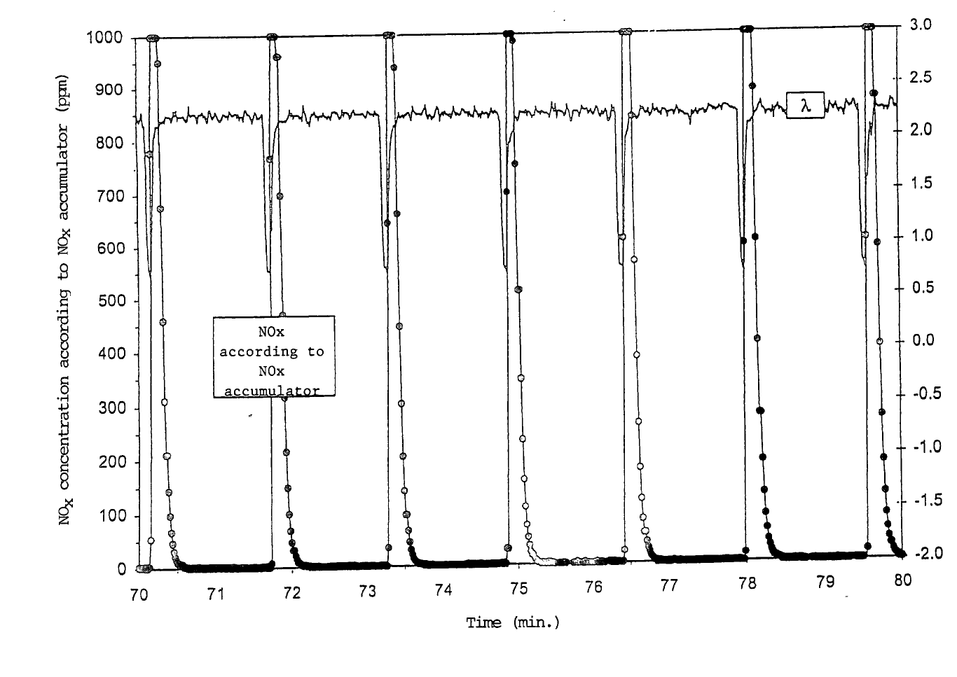

FIG. 2 depicts a diagram which represents the temporal course of the NOₓ concentration in lean-rich shifting operation downstream from a certain solid material as well as the temporal course of the associated λ value,

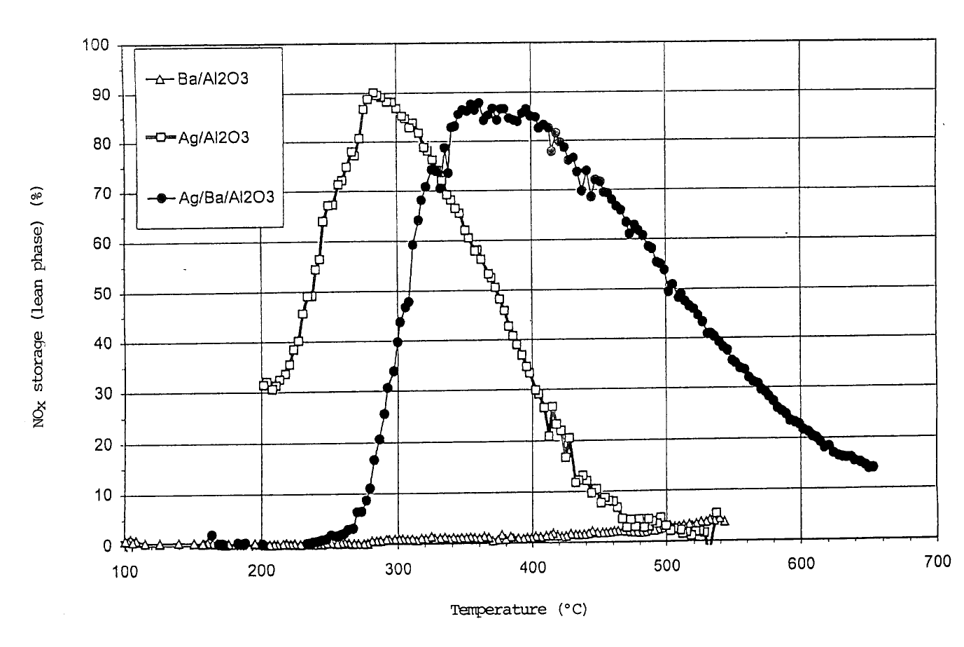

FIG. 3 shows a further diagram which represents the NOₓ storage of various solid materials in the lean part of a lean-rich shifting operation as a function of temperature;

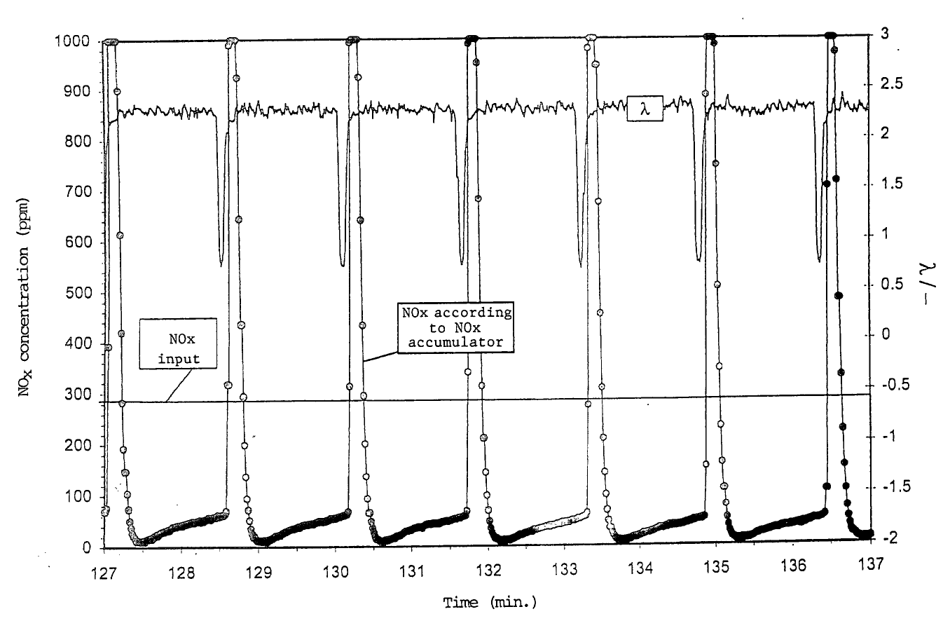

FIG. 4 reveals a further diagram which represents the temporal course of the NOₓ concentration in lead-rich shifting operation downstream from a certain solid material as well as the temporal course of the associated λ value,

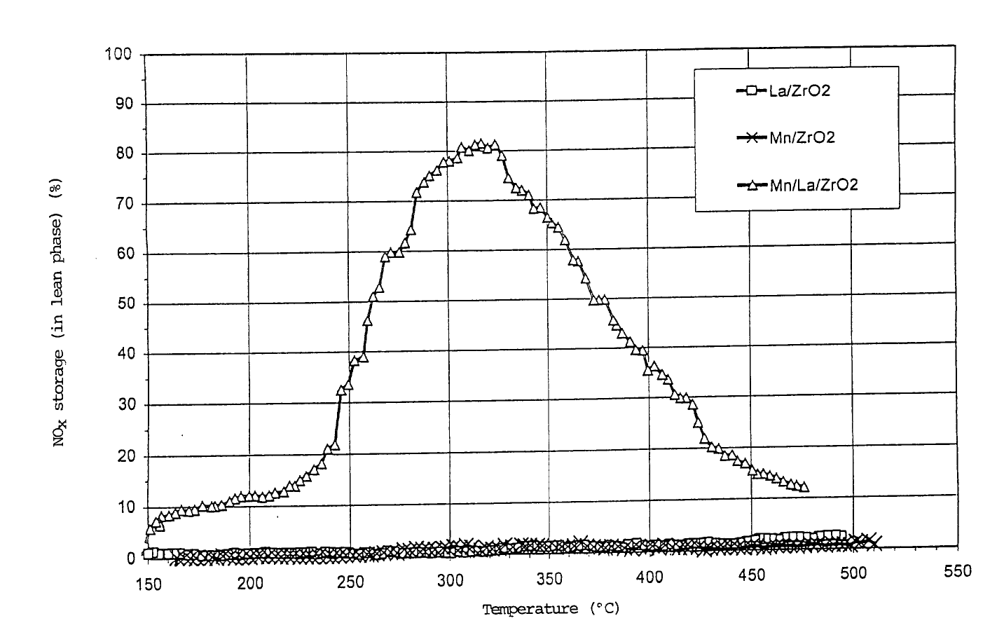

FIG. 5 gives a further diagram which represents the NOₓ storage of various solid materials in the lean part of a lean-rich shifting operation as a function of temperature; and

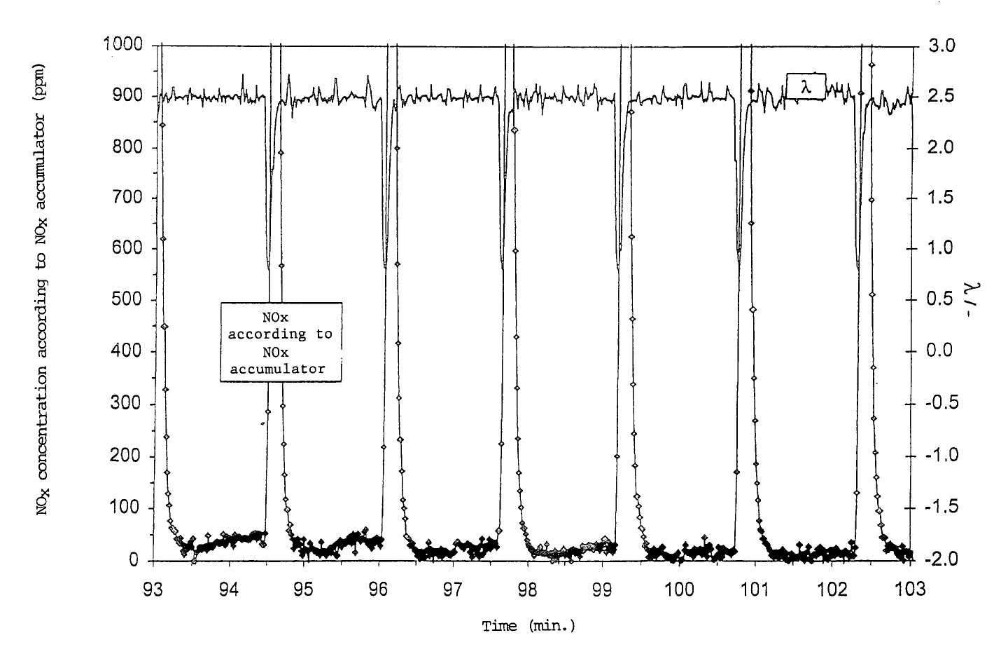

FIG. 6 affords an additional diagram which represents the temporal course of the NOₓ concentration in the lean-rich shifting operation downstream from a certain solid materials, as well as the temporal course of the associated λ value.

The solid materials indicated in greater detail in the subsequent examples were examined in laboratory experiments for their effectiveness. For this, a ceramic honeycomb element monolith with 400 cpsi (cells per square inch) as a mechanical support was coated with the solid material in question and thereafter calcined for 2 hours at 650° C. in air. The test specimens obtained were periodically alternatingly acted upon in a laboratory reactor with oxidizing (lean) test gas and reducing (rich) test gas. The lean-rich shifting operation testing operation in the exhaust gas of an internal combustion engine was simulated with this test method in a realistic manner. The experimental conditions and the test gas compositions are indicated in the following table:

| | Lean | Rich |
|---|---|---|
| Duration | 90 seconds | 4 seconds |
| λ | 2.0 to 2.5 | ca. 0.7 |
| NO | ca. 250 ppm | ca. 250 ppm |
| O₂ | 12.5% | — |
| CO | 0.25% | 9.3% |
| H₂ | 1500 ppm | 2.6% |
| C₃H₆ | 75 ppm | 2700 ppm |
| CO₂ | 10% | 10% |
| H₂O | 10% | 10% |
| N₂ | Residue | Residue |

Here as usual the air-fuel proportion corresponding to an internal combustion engine operated with Otto motor or diesel fuel is to be understood. The gas component C₃H₆ here serves as a representative for the hydrocarbon (HC) usually present in the exhaust gas of an internal combustion engine. The indicated concentrations of the gas components are in relation to volume, those of the solid material components are in relation to mass. The test gas through-put adopted in the laboratory experiments corresponded to a volumetric rate of 20,000 l/h (liters per hour). The test specimen concentrations of the relevant test gas occurring on the output side were continuously recorded during the experiments and online with a suitable measuring apparatus. Of primary interest was the temporal course of NOₓ concentrations or the magnitudes derivable therefrom. The NOₓ concentration is given through the sum of the NO and the NO₂ concentration. The measurement results which were obtained for the solid materials mentioned in the following examples are diagrammatically represented in FIGS. 1 through 6.

The NOₓ storage capacity of solid materials during the lean operation phase of dynamic test operation represents an especially important magnitude. To ascertain this magnitude, the NOₓ amount stored in the test specimen during the lean operation phase was evaluated versus the NOₓ amount infed during this time. The amounts were obtained by integration of the NOₓ concentration course on the input side and output side of the test specimen. The corresponding concentration values are known (input side) or were ascertained by measurement (output side). The NOₓ storage capacity of the solid materials ascertained in this way is shown in the diagrams of FIGS. 1, 3, and 5 as a function of experimental temperature.

The NOₓ concentration courses measured on the output side of the respective test specimen during the test procedure described above are presented in FIGS. 2, 4 and 6 for assessing dynamic NOₓ adsorption and desorption behavior of the solid materials. If the NOₓ concentration lags behind the value of the NOₓ input concentration during the lean test phase lasting 90 seconds, then this indicates an NOₓ adsorption realized with the respective solid material. In the event of a pure NOₓ adsorption, the adsorbed NOₓ amount is released again upon switching to the rich test phase lasting 4 seconds so that the NOₓ concentration measured at the output side of the test specimen correspondingly rises strongly above the level of the NOₓ input concentration. This rise is naturally all the more marked the stronger the NOₓ adsorption occurring in the lead test phase is. By balancing the NOₓ concentrations measured on the output side of the test specimens, it can be determined whether and to what extent an NOₓ turnover occurs in addition to pure NOₓ adsorption, for example with the reducing agent fed in in the rich test phase. As distinct from the solid material of the invention, such an NOₓ turnover is typical for the materials usually used in NOₓ storage catalytic converters. With these, the nitrogen oxides stored under lean conditions are desorbed in a subsequent rich operating phase and simultaneously reduced by the reducing agent so that the NOₓ concentration measured on the output side is typically very small in the rich operation phase.

### EXAMPLE 1

Solid Material: Al₂O₃

Al₂O₃ as porous support (BET surface 180 m²/g) was applied to a monolithic ceramic honeycomb element to provide a corresponding test specimen.

As is apparent from the curve course shown in FIG. 1, the pure carrier shows no NOₓ adsorption in the lean test phase. On the output side of the corresponding test specimen, the constant NOₓ concentration course present on the input side appeared in almost identical fashion. A graphic reproduction of the temporal NOₓ concentration course measured on the output side of the test specimen is therefore not shown.

### EXAMPLE 2

Solid Material: Na (3%)/Al₂O₃

Al₂O₃ as a porous support (BET surface 180 m²/g) was impregnated with an NaNO₃ solution, dried, and subsequently calcined for 5 hours at 650° C. on air. The powder obtained was applied to a monolithic ceramic honeycomb element to produce a corresponding test specimen.

As is apparent from the curve course shown in FIG. 1, the solid material manifests no NOₓ adsorption in the lean test phase. On the output side of the corresponding test specimen, the constant NOₓ concentration course present on the input side appeared in an almost identical manner. Therefore, a graphic representation of the temporal NOₓ concentration course measured at the output side of the test specimen is not provided. Although this solid material contains the strong base-acting alkaline metal Na as a metal component, no NOₓ storage takes place. As already explained, the oxidation of the infed NO to NO₂, or to nitrate, is needed. This function must be brought about through introducing one or more additional components into the solid material.

### EXAMPLE 3

Solid Material: Ag (25%)/Al₂O₃

Al₂O₃ as a porous support (BET surface 180 m²/g) was impregnated with an AgNO₃ solution, dried, and subsequently calcined for 5 hours at 650° C. on air. The powder obtained was applied to a monolithic ceramic honeycomb element to produce a corresponding test specimen.

As emerges from the curve course shown in FIG. 1, NOₓ is stored by this solid material in a temperature range of about 200° C. to about 400° C. in a noticeable proportion in relation to the amount offered under lean conditions. When operating at maximum (about) 290° C., approximately 90% of the NOₓ available in the lean test phase is stored. This relatively strong NOₓ storage capacity of the solid material results because Ag, as an active transition metal component, has disposition over NOₓ storage properties as well as over oxidation-catalytic properties. Owing to this bifunctional property, an NOₓ adsorption occurs on this solid material even without the presence of a metal component from the group of alkaline or alkaline earth or rare earth metals under lean experimental conditions.

### EXAMPLE 4

Solid Material: Ag (25%)/Na (3%)/Al₂O₃

Al₂O₃ as a porous support (BET surface 180 m²/g) was impregnated with an NaNO₃ solution, dried, and subsequently impregnated with an AgNO₃ solution and dried. The powder obtained was subsequently calcined for 5 hours at 650° C. on air and applied to a monolithic ceramic honeycomb element to produce a test specimen.

As is apparent from the curve course shown in FIG. 1, this solid material has, in relation to the Na-free solid material of Example 3, a significantly improved NOₓ storage capacity. The temperature range with strong NOₓ adsorption (temperature window) is comparatively wide. In a temperature range of about 250° C. to 500° C., NOₓ storage amounts to more than 50%.

The temporal course of the NOₓ concentration measured at the output side of the corresponding test specimen measured at about 360° C. is represented. The temporal course of the λ signal likewise presented in FIG. 2 permits the allocation of lean phase and rich phase. In the lean phase, the NOₓ concentration is almost zero, that is, an almost complete storage of nitrogen oxides takes place. With the short-term change to rich test conditions, a steep rise of the NOₓ concentration up to far above the NOₓ input concentration of 250 ppm is observed which is ascribed to a release of the previously stored nitrogen oxides. Here the amount of the nitrogen oxides released in the rich phase corresponds to the amount of nitrogen oxides stored in the lean phase.

As is apparent from the NOₓ storage curve of FIG. 1 and the NOₓ concentration shown in FIG. 2, the NOₓ adsorption and desorption behavior is attained with this example of the solid material of the invention by the synergistic interaction of the individual solid material components. The presence of the transition metal component Ag in the solid material catalyzes the oxidation of the NO present in the test gas necessary for storage. The storage of nitrogen oxides is then taken over by the metal component present in the solid material in the form of the alkaline metal Na. No reductive conversion of the released nitrogen oxides is brought about by the transition metal component Ag during the transition to rich operating conditions.

### EXAMPLE 5

Solid Material: Ba (5%)/Al₂O₃

Al₂O₃ as a porous support (BET surface 180 m²/g) was impregnated with a BaNO₃ solution, dried, and subsequently calcined for 5 hours at 650° C. on air. The powder obtained was applied to a monolithic ceramic honeycomb element to produce a corresponding test specimen.

As is apparent from the curve course shown in FIG. 3, the solid material has no NOₓ adsorption in the lean test phase. On the output side of the corresponding test specimen, the constant NOₓ concentration course present on the input side appeared in an almost identical manner. Therefore, a graphic reproduction of the temporal NOₓ concentration course measured at the output side of the test specimen is not provided. Although the solid material contains the strong base-acting alkaline metal Ba as a metal component, no NOₓ storage takes place. As already explained, oxidation of the infed NO to NO₂ or to nitrate is needed for this. This function must be brought about by one or more additional components in the solid material.

### EXAMPLE 6

Solid Material: Ag (20%)/Ba (17%)/Al₂O₃

Al₂O₃ as a porous support (BET surface 180 m²/g) was impregnated with a Ba(NO₃)₂ solution, dried and subsequently impregnated with an AgNO₃ solution and dried. The power obtained was subsequently calcined for 5 hours at 650° C. on air applied to a monolithic ceramic honeycomb element to produce a corresponding test specimen.

As is apparent from the curve course shown in FIG. 3, this solid material has, in relation to the Ba-free solid material of Example 3, an improved NOₓ storage capacity at temperatures greater than 350° C. The presence of the transition metal component Ag nonetheless first enables the storage of nitrogen oxides by the base metal component (alkaline earth metal Ba).

The temporal course of the NOₓ concentration measured on the output side of the corresponding test specimen at about 400° C. is represented in FIG. 4. The temporal course of the λ signal likewise presented in FIG. 4 permits the allocation of lean phase and rich phase. The behavior corresponds to that of the solid material Ag/Na/Al₂O₃ indicated in Example 4.

### EXAMPLE 7

Solid Material: La (5%)/ZrO₂

ZrO₂ as a porous support (BET surface 60 m²/g) was impregnated with an La(NO₃)₃ solution, dried, and subsequently calcined for 5 hours at 650° C. on air. The powder obtained was applied to a monolithic ceramic honeycomb element to produce a corresponding test specimen.

ZrO₂ is used in this solid material as a porous support and the rare earth metal La is used as the base metal component. Although the solid material here contains the basic-acting rare earth metal La as a metal component, the solid material shows no NOₓ adsorption in the lean test phase analogously to the solid materials indicated in Example 2 and Example 5. The NOₓ storage presented in FIG. 5 is, for this reason, almost zero in the entire temperature range examined. Therefore, a reproduction of the temporal NOₓ concentration course measured on the output side of the test specimen is not provided here.

### EXAMPLE 8

Solid Material: Mn (17%)/ZrO₂

ZrO₂ as a porous support (BET surface 60 m²/g) was impregnated with an Mn(NO₃)₂ solution, dried, and subsequently calcined for 5 hours at 650° C. on air. The powder obtained was applied to a monolithic ceramic honeycomb element to produce a corresponding test specimen.

Mn is used as a transition metal component in this solid material. The solid material likewise manifests no NOₓ adsorption in the lean test phase. The NOₓ storage shown in FIG. 5 is for this reason almost zero in the entire temperature range examined. Therefore, a graphic reproduction of the temporal NOₓ concentration course measured on the output side of the test specimen is not provided.

### EXAMPLE 9

Solid Material: Mn₂O₃ (25%)/La (12%)/ZrO₂

ZrO₂ as a porous support (BET surface 60 m²/g) was impregnated with an La(NO₃)₃ and subsequently with an Mn(NO₃)₂ solution and dried. The powder obtained was subsequently calcined for 5 hours at 650° C. on air, and was applied to a monolithic ceramic honeycomb element to produce a corresponding test specimen.

The rare earth metal La is used in this solid material as a real NOₓ storage material. Mn is present in addition as a transition metal component. As can be seen in FIG. 5, the interaction of these components results in a high NOₓ storage capacity corresponding to the mechanism discussed below. The dynamic NOₓ adsorption and desorption behavior corresponds to the solid materials indicated in Example 4 and Example 6. The temporal course of the NOₓ concentration resulting in the laboratory test (experimental temperature ca. 320° C.) is presented in FIG. 6. Analogous conditions result in comparison with Example 4 and Example 6, owing to which the curve course corresponds to the curve course represented in FIG. 2 or FIG. 4.

Because of the behavior of the solid materials of the invention described in Examples 4, 6 and 9, these solid materials are especially suited for use in predominantly lean-operated internal combustion engines. In particular, owing to the position of the temperature window of NOₓ adsorption and the λ-controlled NOₓ desorption in the range of typically arising exhaust gas temperatures, the solid material is preferably suited for NOₓ removal in an exhaust gas catalytic converter system of corresponding internal combustion engines.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A solid material for absorption and desorption of nitrogen oxides in gases, comprising:
a porous support;
at least one metal component comprising a metal selected from the group consisting of alkaline metals, alkaline earth metals, and rare earth metals;
at least one transition metal component comprising a transition metal selected from the group consisting of titanium (Ti), vanadium (V), chromium (Cr), manganese (Mn), iron (Fe), cobalt (Co), zinc, (Zn), zirconium (Zr), niobium (Nb), molybdenum (Mo), silver (Ag), hafnium (Hf), and tungsten (W); and
a main group metal component;
wherein said main group metal component is selected from the group consisting of indium (In), tin (Sn), antimony (Sb), lead (Pb), and bismuth (Bi); and
wherein the solid material stores the nitrogen oxides in an oxidizing atmosphere and desorbs the stored nitrogen oxides in a reducing atmosphere.

2. A solid material according to claim 1, wherein the gases are internal combustion engine exhaust gases.

3. A solid material according to claim 1, wherein said porous support comprises at least one compound selected from the group consisting of aluminum oxide (Al₂O₃), zirconium oxide (ZrO₂), titanium dioxide (TiO₂), cerium dioxide (CeO₂) and silicon dioxide (SiO₂).

4. A solid material according to claim 1,
wherein said alkaline metals comprise at least one metal selected from the group consisting of sodium (Na), potassium (K), rubidium (Rb), and cesium (Cs);
wherein said alkaline earth metals comprise at least one metal selected from the group consisting of magnesium (Mg), calcium (Ca), strontium (Sr), and barium (Ba), and
wherein said rare earth metals comprise at least one metal selected from the group consisting of lanthanum (La), cerium (Ce), praseodymium (Pr), neodymium (Nd), samarium (Sm), europium (Eu), gadolinium (Gd), terbium (Tb), and dysprosium (Dy).

5. A solid material according to claim 1, wherein at least one of said at least one metal components is present in at least one form selected from the group consisting of in a compound as oxide, in a compound as hydroxide, in a compound as carbonate, and as an element.

6. A solid material according to claim 1, wherein at least one of said transition metal and said main group metal is present in at least one form selected from the group consisting of in a compound as oxide, in a compound as hydroxide, in a compound as carbonate, and as an element.

7. A solid material according to claim 1, wherein said metal component is present as a mixed oxide with said main group metal component or as a mixed oxide with said transition metal component.

8. A solid material according to claim 1, wherein said transition metal component is present as a mixed oxide with said main group metal component.

9. A solid material according to claim 1, wherein the solid material is constructed as a molded element.

10. A solid material according to claim 9, wherein said molded element is in one of pellet form, extrudate form, or applied on a geometric support.

11. A solid material according to claim 10, wherein said at least one of said metal component, said transition metal components, and said main group metal components are separated from one another as layers on said geometric support.

12. A solid material according to claim 10, wherein at least one of said metal component, said transition metal component, and said main group metal component are present as a powder mixture on said geometrical support.

13. A process for adsorption and desorption of nitrogen oxides in gases, comprising:
a single solid material;
wherein said single solid material adsorbs and desorbs the nitrogen oxides and comprises:
a porous support;
at least one metal component comprising a metal selected from the group consisting of alkaline metals, alkaline earth metals, and rare earth metals;
at least one transition metal component comprising a transition metal selected from the group consisting of titanium (Ti), vanadium (V), chromium (Cr), manganese (Mn), iron (Fe), cobalt (Co), zinc, (Zn), zirconium (Zr), niobium (Nb), molybdenum (Mo), silver (Ag), hafnium (Hf), and tungsten (W); and
a main group metal component;
wherein said main group metal component is selected from the group consisting of indium (In), tin (Sn), antimony (Sb), lead (Pb), and bismuth (Bi); and
wherein the solid material stores the nitrogen oxides in an oxidizing atmosphere and desorbs the stored nitrogen oxides in a reducing atmosphere.

14. A process according to claim 13, wherein the gases are internal combustion engine exhaust gases.

15. A process according to claim 13, wherein at least two molded elements comprising said single solid material are provided.

16. A process according to claim 15, wherein said at least two molded elements are provided in series.

17. A process according to claim 14, wherein the nitrogen oxides are at least partially converted to nitrates subsequent to the desorption in the exhaust gas of the internal combustion engine.

18. A process for controlling nitrogen oxide emission from an internal combustion engine, comprising:
using a solid material for adsorption of nitrogen oxides in an oxidizing atmosphere and desorption of stored nitrogen oxides in a reducing atmosphere;
wherein said solid material comprises:
a porous support;
at least one metal component comprising a metal selected from the group consisting of alkaline metals, alkaline earth metals, and rare earth metals;
at least one transition metal component comprising a transition metal selected from the group consisting of titanium (Ti), vanadium (V), chromium (Cr), manganese (Mn), iron (Fe), cobalt (Co), zinc, (Zn), zirconium (Zr), niobium (Nb), molybdenum (Mo), silver (Ag), hafnium (Hf), and tungsten (W); and
a main group metal component; and
wherein said main group metal component is selected from the group consisting of indium (In), tin (Sn), antimony (Sb), lead (Pb), and bismuth (Bi).

19. A process according to claim 18, wherein said internal combustion engine is a primarily lean-operated engine.
